(19) United States
(12) Patent Application Publication
(10) Pub. No.: US 2018/0142759 A1
(43) Pub. Date: May 24, 2018

(54) TORSIONAL VIBRATION DAMPER AND HYBRID DRIVE TRAIN

(71) Applicant: Schaeffler Technologies AG & Co. KG, Herzogenaurach (DE)

(72) Inventor: Marc Finkenzeller, Gengenbach (DE)

(73) Assignee: Schaeffler Technologies AG & Co. KG, Herzogenaurach (DE)

(21) Appl. No.: 15/572,132

(22) PCT Filed: Apr. 22, 2016
(86) PCT No.: PCT/DE2016/200191

§ 371 Date: Nov. 6, 2017

(30) Foreign Application Priority Data
May 20, 2015 (DE) 10 2015 006 366.9
Jun. 24, 2015 (DE) 10 2015 211 680.8

(51) Int. Cl. F16F 15/123; F16D 3/12; F16D 13/52; F16D 23/12; B60K 6/48; B60K 6/387

(52) U.S. Cl. CPC F16F 15/123; F16D 3/12; F16D 13/52; F16D 2121/20; B60K 6/48; B60K 6/387; F16D 2023/123; F16D 23/12

(57) ABSTRACT

A torsional vibration damper includes a rotational axis, an input part, an output part, and a damper device. The input part is rotatable about the rotational axis. The output part is rotatable about the rotational axis and rotatable relative to the input part to a limited extent. The damper device acts between the input part and the output part. The output part includes a clutch device, adjustable between an open actuating position and a closed actuating position, and an actuating device for opening and closing the clutch device.

### CROSS-REFERENCE TO RELATED APPLICATIONS

This application is the U.S. National Phase of PCT Appln. No. PCT/DE2016/200191 filed Apr. 22, 2016, which claims priority to German Application Nos. DE102015006366.9 filed May 20, 2015 and DE102015211680.8 filed Jun. 24, 2015, the entire disclosures of which are incorporated by reference herein.

### TECHNICAL FIELD

The present disclosure relates to a torsional vibration damper, in particular a dual-mass flywheel, having an input part and an output part with a common rotational axis, about which the input part and the output part can rotate together and can be rotated relative to one another to a limited extent, and a spring/damper device acting between the input part and the output part. Moreover, the present disclosure relates to a hybrid drive train having a combustion engine and an electrical machine with a stator and a rotor.

### BACKGROUND

WO 2013/087055 A1 discloses a clutch device having an actuating device for a drive train of a motor vehicle having a combustion engine, an electrical machine with a stator and a rotor, and a transmission device, wherein the clutch device is arranged in the drive train between the combustion engine, on the one hand, and the electrical machine and transmission device, on the other hand, wherein the clutch device and the actuating device are integrated into the rotor of the electrical machine.

DE 10 2004 023 673 A1 discloses a method for controlling the drive train of a hybrid vehicle, which has a parallel hybrid drive with series arrangement of an internal combustion engine, an electric machine designed as a motor-starter-generator and provided with a flyweight, and a drive transmission connected on the output side to a final drive, in which a first controllable separating friction clutch is arranged between the internal combustion engine and the electric machine, and a second controllable separating friction clutch is arranged between the electric machine and the drive transmission, wherein the internal combustion engine is started from the purely electric mode by means of the electric machine, wherein the second separating clutch is controlled in the slip mode, then the flyweight is accelerated by means of the electric machine to build up an excess angular momentum Jₛ·Δn, whereupon the internal combustion engine is started by closing the first separating clutch.

Thus, there is a long-felt need to structurally and/or functionally improve a torsional vibration damper mentioned at the outset. Moreover there is a need to structurally and/or functionally improve a hybrid drive train mentioned at the outset.

### SUMMARY

Example aspects broadly comprise a torsional vibration damper, in particular a dual-mass flywheel, having an input part and an output part with a common rotational axis, about which the input part and the output part can rotate together and can be rotated relative to one another to a limited extent, and a spring/damper device acting between the input part and the output part, in which the output part has a clutch device, which can be adjusted between an open actuating position and a closed actuating position and has an actuating device for opening and closing the clutch device.

The torsional vibration damper can be used for arrangement in a motor vehicle. The torsional vibration damper can be used for arrangement in a hybrid drive train. The torsional vibration damper can be used to reduce torsional vibrations which are excited by periodic processes. The torsional vibration damper can be used to reduce torsional vibrations which are excited by a combustion engine. The terms “input part” and “output part” can refer to a line flow direction starting from a combustion engine.

The spring/damper device can have a spring device. The spring device can have at least one energy storage device. The at least one energy storage device can be supported on the input part, on the one hand, and on the output part, on the other hand. The at least one energy storage device can be a helical spring. The at least one energy storage device can be a compression spring. The at least one energy storage device can be a curved coil spring. The spring/damper device can have a friction device. The input part can be used for drive connection to a combustion engine. The output part can be used for a drive connection on the vehicle-wheel side.

The input part can have a flange section. The input part can have a cap section. The flange section and the cap section can delimit a receiving space for the at least one energy storage device. The receiving space can have a toroidal shape. The input part can have supporting sections for the at least one energy storage device which project into the receiving space. The output part can have a flange part. The flange part can be arranged axially between the flange section and the cap section. The flange part can have radially outward-projecting extensions. The extensions can project into the receiving space. The extensions can be used as supporting sections for the at least one energy storage device which are situated on the same side as the output part. The torsional vibration damper can have a bearing device for the mutual rotatable support of the input mass and of the output mass. The bearing device can have a rolling bearing, in particular a ball bearing.

The output part can have a pot-type section. The pot-type section can have an interior. The clutch device with the actuating device can be arranged at least approximately completely in the interior. The clutch device and the actuating device can be integrated into the output part. The clutch device with the actuating device can be arranged radially at least substantially within the interior. A radial direction is a direction perpendicular to the axis of rotation. The clutch device with the actuating device can be arranged axially at least substantially within the interior. An axial direction is a direction of extent of the rotational axis. The clutch device and the actuating device can be nested partially in one another.

The pot-type section and the flange part of the output part can be connected in a fixed manner, in particular riveted, to one another. The pot-type section can have a bottom section, a wall section and an aperture side. The bottom section of the pot-type section can be connected to the flange part. The interior can be delimited by the bottom section and the wall section. The pot-type section can form a housing for the clutch device with the actuating device. The pot-type section can form an outer cage of the clutch device. The torsional vibration damper can have an output shaft. The output shaft can be used to connect the torsional vibration damper to a drive train on the output side. An output side can be a side facing a vehicle wheel.

The clutch device can have a multiplate clutch. The multiplate clutch can be a dry multiplate clutch. The clutch device can have first plates. The clutch device can have an outer cage. The first plates can be connected for conjoint rotation to the outer cage. The clutch device can have second plates. The clutch device can have an inner cage. The first plates can be connected for conjoint rotation to the inner cage. The first plates and the second plates can be arranged alternately. The first plates and/or the second plates can have friction linings. The clutch device can have a pressure plate. The bottom section of the pot-shaped section can be used as the pressure plate. The clutch device can have a contact plate. The contact plate can be moved axially to a limited extent relative to the pressure plate. The first plates and the second plates can be clampable between the pressure plate and the contact plate for frictional transmission of mechanical power. The clutch device can have a spring device. The spring device can act upon the clutch device in an opening direction. The spring device can comprise wave springs. The wave springs can be arranged between the plates of the multiplate clutch.

The clutch device can have a clutch input part and a clutch output part. The pot-type section of the output part of the torsional vibration damper, the outer cage, the pressure plate, the first plates and/or the contact plate can belong to the clutch input part. The second plates, the inner cage and/or the output shaft of the torsional vibration damper can belong to the clutch output part.

The clutch device can allow increasing power transmission depending on actuation, starting from a completely disengaged actuating position, in which there is essentially no power transmission between the clutch input part and the clutch output part, up to a completely engaged actuating position, in which there is essentially full power transmission between the clutch input part and the clutch output part, wherein power transmission between the clutch input part and the clutch output part can take place nonpositively, in particular frictionally. Conversely, decreasing power transmission can be allowed depending on actuation, starting from a fully engaged actuating position, in which there is essentially full power transmission between the clutch input part and the clutch output part, up to a completely disengaged actuating position, in which there is essentially no power transmission between the clutch input part and the clutch output part. A fully engaged actuating position can be the closed actuating position. A fully disengaged actuating position can be the open position. With the aid of the actuating device, the contact pressure plate of the clutch device can be axially movable. With the aid of the actuating device, the clutch device can be opened or closed. With the aid of the actuating device, the clutch device can be engaged or disengaged.

The actuating device can have a ramp device. The ramp device can be adjustable by rotation. The ramp device can have first ramps and second ramps. The first ramps and the second ramps can be rotatable relative to one another. Rotation of the first ramps and of the second ramps relative to one another can bring about a change in an axial spacing. Rolling elements, in particular balls, can be arranged between the first ramps and the second ramps. The ramps can form races for the rolling elements. The ramps can be designed as rolling element ramps, in particular as ball ramps. The ramps can be arranged in a manner distributed in the circumferential direction of the clutch device. The ramps can be oblique relative to a plane perpendicular to the rotational axis of the clutch device. The ramps can rise and/or fall in the circumferential direction of the clutch device. The ramps can rise on one side. The ramps can rise on both sides. The first ramps and the second ramps can be of geometrically complementary design to one another. The first ramps can correspond to the second ramps in such a way that, when the first ramps and the second ramps are rotated relative to one another, the first ramps and the second ramps move away from one another or toward one another in the direction of extent of the rotational axis of the clutch device. The first ramps can support the rolling elements radially from the inside. The second ramps can support the rolling elements radially from the outside. The rolling elements can have a diameter such that they are held captive between the first ramps and the second ramps. The rolling elements can be arranged in a rolling element cage. An association between the rolling elements and the ramps can thereby be ensured.

The actuating device can have a first pilot control device. The first pilot control device can be introduced to initiate closure of the clutch device in a traction mode. The first pilot control device can be actuable without additional energy. The first pilot control device can have a freewheel device. The freewheel device can have a first freewheel part and a second freewheel part. The first freewheel part and the second freewheel part can be rotatable relative to one another in a first direction of rotation. In a second direction of rotation opposite to the first direction of rotation, rotatability can be blocked. In the first direction of rotation, in which rotatability can be enabled, the second freewheel part can have a higher speed than the first freewheel part. In the second direction of rotation, in which rotatability can be blocked, the first freewheel part can have a higher speed than the second freewheel part. The first freewheel part can be connected for conjoint rotation to the output part of the torsional vibration damper. The first freewheel part can have a pot-type section. The pot-type section can also be referred to as a freewheel pot. The second freewheel part can be connected for conjoint rotation to the output shaft of the torsional vibration damper. Thus, the freewheel device can initiate closure of the clutch device when the output part of the torsional vibration damper is at a higher speed than the output shaft.

The actuating device can have a second pilot control device. The second pilot control device can be used to initiate closure of the clutch device in an overrun mode. The second pilot control device can be actuable by means of additional energy. The second pilot control device can be electrically actuable. The second pilot control device can have an actuator device. The actuator device can have a magnetic clutch. The magnetic clutch can have a clutch stator, a rotary transmitter and a clutch disk. The clutch stator can be connected to a torque support. The clutch stator can have an electric coil. The rotary transmitter can be connected in a fixed manner to the output shaft of the torsional vibration damper. The clutch disk can be connected for conjoint rotation to the first freewheel part. The clutch disk can be movable axially to a limited extent relative to the first freewheel part. The clutch disk can be connected to the first freewheel part with the aid of leaf springs.

Other aspects broadly comprise a hybrid drive train having a combustion engine and an electrical machine with a stator and a rotor, wherein the drive train has a torsional vibration damper of this kind.

The drive train can be a motor vehicle drive train. The drive train can have a starting device. The drive train can have a friction clutch. The drive train can have a hydrodynamic torque converter. The drive train can have a transmission device. The drive train can have at least one drivable vehicle wheel.

The torsional vibration damper can be arranged between the combustion engine, on the one hand, and the electrical machine and the at least one drivable vehicle wheel, on the other hand. The starting device, the friction clutch device, the hydrodynamic torque converter and/or the transmission device can be arranged between the torsional vibration damper and the at least one drivable vehicle wheel.

The combustion engine can be connected to the input part of the torsional vibration damper. The rotor of the electrical machine can be connected to an output shaft of the torsional vibration damper. It is possible for the electrical machine to be operable as a motor and/or as a generator.

In summary and in other words, the present disclosure thus gives rise, inter alia, to a damper and to an electrically controlled hybrid separating clutch. The hybrid separating clutch can be used to couple and decouple a combustion engine to and from an electric machine as well as to and from a drive train. The clutch can be connected directly to the damper. The clutch can include a dry multiplate clutch, a ball ramp system, a magnetic clutch as a pilot control element in an overrun mode, and a freewheel as a pilot control element in a traction mode. With the aid of a small magnetic clutch, the clutch can be closed in the overrun mode. For this purpose, a coil integrated into a stator can be energized, resulting in a magnetic field. It is thereby possible for a disk of the magnetic clutch, which can be linked in an axially movable manner to a freewheel pot by means of leaf springs, to be attracted to a rotary transmitter and for a certain torque to be transmitted frictionally. In this case, the disk can rotate at a speed of the electric machine, and the rotary transmitter can be connected firmly to a shaft used for connection to the combustion engine. In the case of a speed difference between the combustion engine and the electric machine, rotation of the ramp system can occur. During this process, an electrically produced friction moment of the magnetic clutch can be converted by the ball ramp system into an axial contact force, by means of which clutch plates can be clamped. A main torque can be transmitted via a multiplate clutch. In the traction mode, the ball ramp system can be rotated by means of a small freewheel, and an axial contact force on a multiplate assembly can also be produced. Here, torque transmission can be accomplished without additional actuating energy. As soon as a pilot control torque disappears, when the freewheel is overrun or the magnetic clutch is not energized, the ramp system can be pushed back into a zero position by wave springs. The wave springs can additionally be used to separate the clutch plates, thereby making it possible to reduce a drag torque.

The present disclosure provides a clutch device integrated into the output part which makes it possible to connect a combustion engine to a drive train or to separate it from the drive train. With the aid of the clutch device, the combustion engine can be coupled to the drive train within a very short period of time and it is possible to transmit a torque from the combustion engine. Electric actuation of the clutch device is made possible. An installation space requirement of the clutch device and of the actuating device is reduced. A production outlay will be reduced. The clutch device can be actuated by purely electric means. Actuating energy is kept as low as possible. Efficiency of the actuating device is increased. Hydraulic actuation is avoided. Requirements in terms of accuracy demands on a torque control system for the clutch device are kept low. The clutch device and the actuating device are accommodated in the interior.

### BRIEF DESCRIPTION OF THE DRAWINGS

Illustrative embodiments of the present disclosure are described in greater detail below with reference to the figures, in which:

FIG. 1 shows a drive train of a motor vehicle having a parallel full hybrid drive and a torsional vibration damper arranged in the drive train and having a clutch device with an actuating device,

FIG. 2 shows a detail view of an illustrative embodiment of a torsional vibration damper without an electric machine,

FIG. 3 shows a perspective view of the torsional vibration damper without an electric machine from FIG. 2, and

FIG. 4 shows an overall view of the torsional vibration damper with an electric machine from FIGS. 2 and 3.

### DETAILED DESCRIPTION

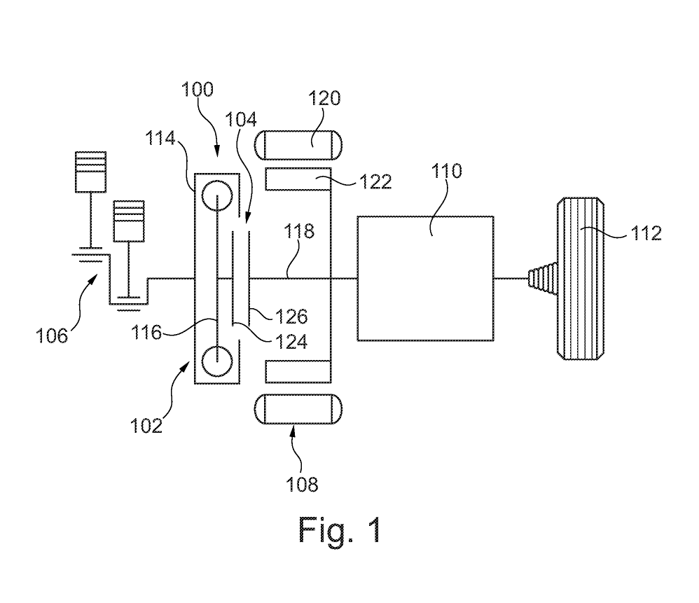

FIG. 1 shows a drive train 100 of a motor vehicle having a parallel full hybrid drive and a torsional vibration damper 102 arranged in the drive train 100 and having a clutch or clutch device 104 with an actuating device. The drive train 100 has a combustion engine 106, the torsional vibration damper 102 with clutch 104 and actuating device, an electrical machine 108, a transmission 110 and at least one drivable wheel 112. The torsional vibration damper 102 has an input part 114, an output part 116 and an output shaft 118. The electrical machine 108 has a stator 120 and a rotor 122. The electrical machine 108 can be operated as a motor and/or as a generator.

The torsional vibration damper 102 with clutch 104, actuating device and output shaft 118 is arranged between the combustion engine 106, on the one hand, and the electrical machine 108 as well as the transmission 110, on the other hand. A starting element, such as a friction clutch or hydrodynamic converter, can be arranged between the output shaft 118 and the transmission 110.

The clutch 104 is arranged in the drive train 100 between the output part 116 of the torsional vibration damper 102 and the output shaft 118. The clutch 104 has a clutch input part 124 and a clutch output part 126. The clutch input part 124 is connected to the output part 116 of the torsional vibration damper 102. The clutch output part 126 is connected to the output shaft 118. The rotor 122 of the electrical machine 108 is connected to the output shaft 118.

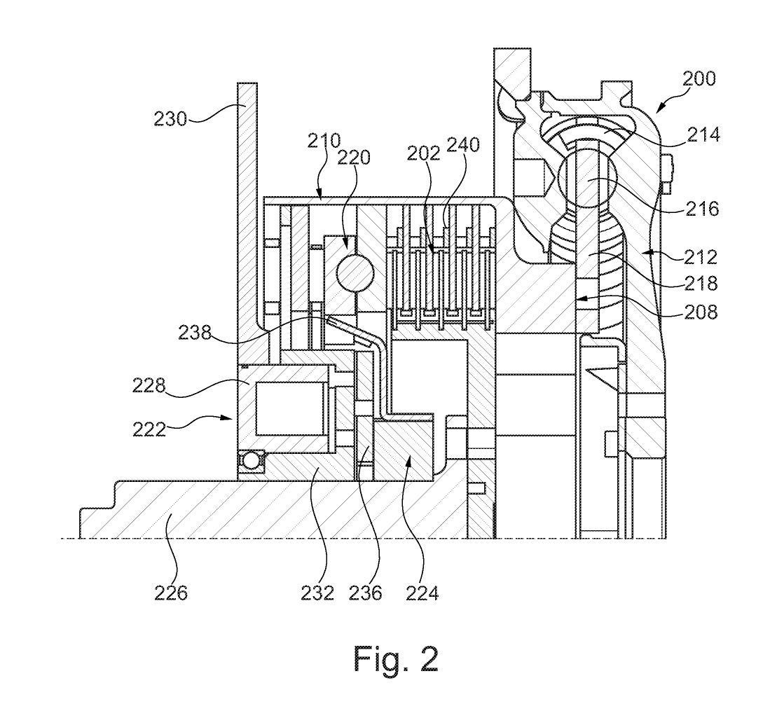

FIGS. 2 to 4 relate to illustrative embodiments of a torsional vibration damper 200 for a drive train of a hybrid vehicle as well as of a drive train for a hybrid vehicle. Features which are denoted as not essential to the present disclosure in the present description should be understood to be optional. Therefore, the following description also relates to further illustrative embodiments of the torsional vibration damper 200 for a drive train of a hybrid vehicle and of the drive train for a hybrid vehicle which comprise partial combinations of the features explained below. In other respects, attention is drawn especially to FIG. 1 and to the associated description by way of supplementary information.

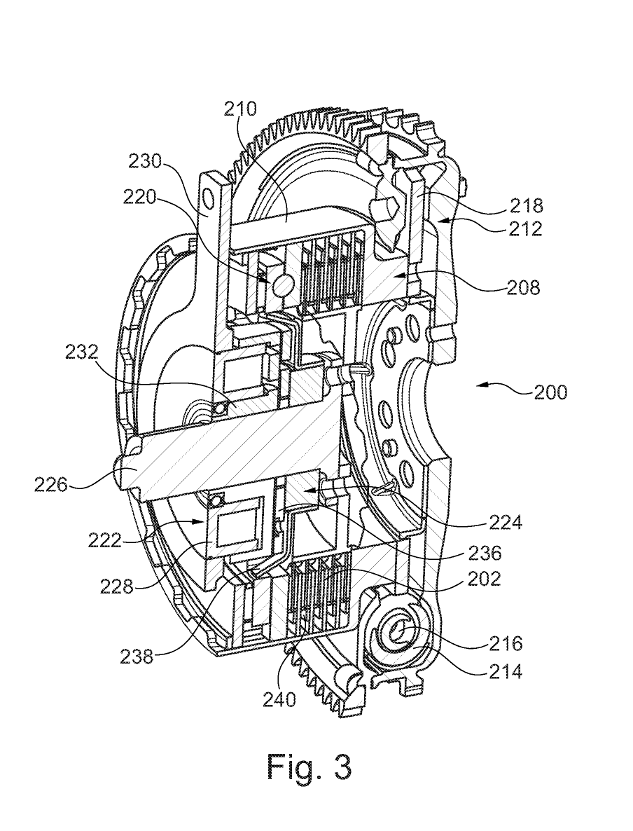

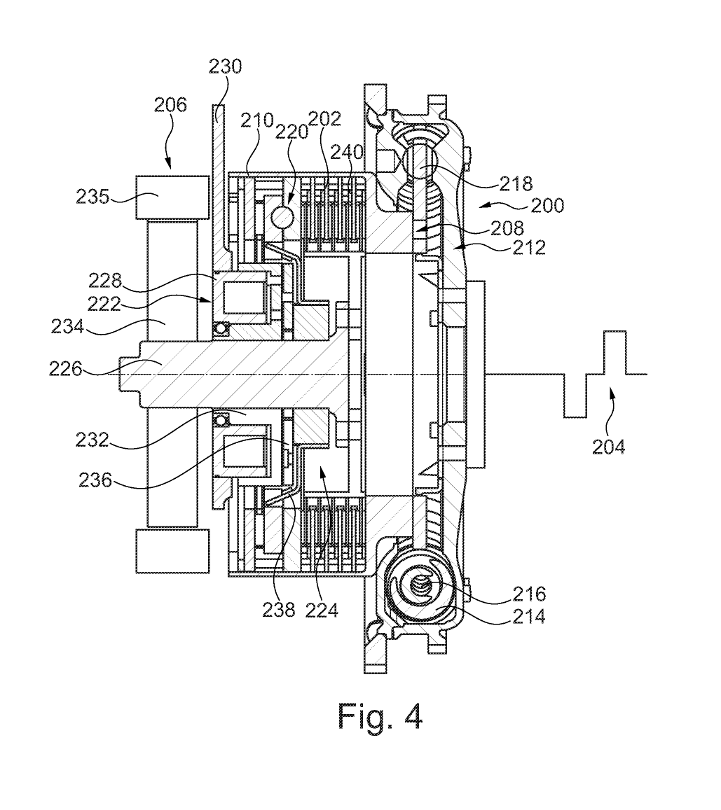

FIG. 2 shows, in a detail view, a section through a torsional vibration damper 200 having a hybrid separating clutch or clutch device 202 (K0 clutch) for coupling and decoupling an internal combustion engine or combustion engine 204 illustrated in FIG. 4 to and from an electric machine or electrical machine 206, illustrated in FIG. 3, of a hybrid drive train. The hybrid separating clutch 202 is part of a secondary mass or output part 208, i.e. a mass on the output side, of the torsional vibration damper 200, which may be designed as a dual-mass flywheel, wherein the hybrid separating clutch 202 is integrated into the secondary mass 208 of the torsional vibration damper 200 and may be of integral design with the secondary mass 208 of the torsional vibration damper 200. In this case, the hybrid separating clutch 202 may be integrated into an output flange or pot-type section 210 of the output part of the torsional vibration damper 200.

The torsional vibration damper 200 furthermore has a primary mass or input part 212, to which the secondary mass 208 is connected with limited elasticity in the circumferential direction of the torsional vibration damper 200 by means of damping elements or energy storage devices 214, designed as compression springs or curved coil springs, for example. For this purpose, the primary side is equipped with a toroidal or segmentally toroidal channel or receiving space 216 for receiving the damping elements 214, which are spaced apart in the circumferential direction and which each have at least one end which is situated in contact with contact regions of a flange disk or flange part 218 or can be brought into contact with said flange disk 218. The flange disk 218 is connected for conjoint rotation to the output flange 210 or formed integrally with the output flange 210. The damping elements may be mounted with the ability for sliding movement in sliding shells, which are arranged in the toroidal channel 216 on the primary side of the torsional vibration damper 200. If the internal combustion engine 204 cannot be started by means of the electric machine 206, it is advisable, in the outer circumference of the toroidal channel 216, to provide a starter pinion for conjoint rotation with the primary mass 212 of the torsional vibration damper 200.

The hybrid separating clutch 202 integrated into the output flange 210 may be designed as a dry multiplate clutch, which has a ramp system or ramp device 220, a magnetic clutch 222 as a pilot control element in the overrun mode, and a freewheel or one-way clutch device 224 as a pilot control element in the traction mode. The torsional vibration damper 200 is connected by an output shaft 226 to an input side of a single or dual clutch or of a torque converter.

With the aid of the magnetic clutch 222, which may be likewise integrated into the output flange 210, the hybrid separating clutch 202 can be closed in the overrun mode. For this purpose, the magnetic clutch 222 has a stator 228 having at least one integrated coil. The stator 228 is fixed non-rotatably on a nonrotating component, e.g. a clutch bell, by means of a torque support 230 secured in its outer circumference. In the illustrative embodiment shown, the inner circumference of the stator 228 is supported by means of a rolling bearing on the output shaft 226, to be more precise on a rotary transmitter 232 secured on the output shaft 226.

The abovementioned electric machine 206, which may be designed as a motor-starter-generator, furthermore acts on the output shaft 226. A rotor 234 of the electric machine 206 may be connected for conjoint rotation to the output shaft 226, wherein the rotor 234 can be arranged directly on the output shaft 226 or can be connected to the output shaft 226 via one or more transmission stages. It is also conceivable here for the rotor 234 of the electric machine 206 to be arranged in the outer circumference of the output flange 210 and to be connected to the output shaft 226.

The stator 235 of the electric machine 206, through the energization of which the electric machine 206 can be driven in the motor mode and in which a voltage is induced by rotation of the rotor 234 when the electric machine 206 is operating in the generator mode, is arranged in the outer circumference of the rotor 234.

When the coil of the stator 228 of the magnetic clutch 222 is energized, a magnetic field is formed, by means of which a friction disk or disk 236 of the magnetic clutch 222, which is linked movably to a freewheel pot 238 in the axial direction of the torsional vibration damper 200 by means of leaf springs, is attracted to the rotary transmitter at 232 secured on the output shaft 226, thus allowing a certain torque to be transmitted by frictional engagement. Owing to the frictional engagement, the friction disk rotates at a speed of the electric machine.

Owing to the speed difference between the internal combustion engine 204 and the electric machine 206, there is a rotation of the ramp system 220, which may be designed as a ball ramp system. In this case, the electrically produced friction torque of the magnetic clutch 222 is converted by the ball ramp system as a pilot control torque into an axial contact force with which the clutch plates are clamped. The main torque is transmitted via the multiplate clutch. To increase the pilot control torque, it is also possible for a transmission, e.g. a single- or two-stage planetary transmission, to be provided between the magnetic clutch 222 and the ball ramp system.

In the traction mode, the ball ramp system is rotated by way of the freewheel 224, wherein an axial contact force on the plate assembly is likewise produced. In this case, torque transmission is accomplished without additional actuating energy.

As soon as the pilot control torque disappears, i.e. the freewheel 224 is overtaken or the magnetic clutch 222 is not energized, the ramp system 220 is pushed back into its zero position by wave springs 240, thereby decoupling the internal combustion engine 204. The wave springs 240 are additionally used to separate the clutch plates, this being intended to reduce the drag torque.

In summary, the hybrid separating clutch 202 integrated into the torsional vibration damper 200 can be actuated electrically to produce an overrun torque. In the traction mode, torque transmission is performed without energy input by means of the freewheel 224, which is used as the pilot control element of the ball ramp system. The main torque is transmitted via a dry multiplate clutch.

### LIST OF REFERENCE SIGNS

100 drive train
102 torsional vibration damper
104 clutch
106 combustion engine
108 electrical machine
110 transmission
112 drivable wheel
114 input part
116 output part
118 output shaft
120 stator
122 rotor
124 clutch input part
126 clutch output part
200 torsional vibration damper
202 hybrid separating clutch, clutch device
204 internal combustion engine
206 electric machine
208 secondary mass, output part
210 output flange, pot-type section
212 primary mass, input part
214 damping element, energy storage device
216 channel, receiving space
218 flange disk, flange part
220 ramp system, ramp device
222 magnetic clutch
224 freewheel
226 output shaft
228 stator
230 torque support
232 rotary transmitter
234 rotor
235 stator
236 friction disk
238 freewheel pot
240 wave spring

1-10. (canceled)

11. A torsional vibration damper comprising:
a rotational axis;
an input part, rotatable about the rotational axis;
an output part rotatable about the rotational axis and rotatable relative to the input part to a limited extent; and,
a damper device acting between the input part and the output part, the output part comprising a clutch device, adjustable between an open actuating position and a closed actuating position, and an actuating device for opening and closing the clutch device.

12. The torsional vibration damper of claim 11 wherein:
the output part has a pot-type section with an interior; and,
the clutch device and the actuating device are arranged at least partially in the interior.

13. The torsional vibration damper of claim 12 wherein the clutch device and the actuating device are arranged completely in the interior.

14. The torsional vibration damper of claim 11 wherein the actuating device comprises:
a ramp device with first ramps and second ramps;
a first pilot control device for initiating closure of the clutch device in a traction mode; and,
a second pilot control device for initiating closure of the clutch device in an overrun mode.

15. The torsional vibration damper of claim 14 wherein the first pilot control device includes a freewheel device.

16. The torsional vibration damper of claim 14 wherein the second pilot control device includes an actuator device.

17. The torsional vibration damper of claim 14 wherein the ramp device comprises a ball in contact with the first ramps and the second ramps.

18. The torsional vibration damper of claim 17 wherein initiating closure of the clutch device includes rotating the first ramps relative to the second ramps to axially expand the ramp device.

19. The torsional vibration damper of claim 14 wherein the ramp device contacts the clutch device.

20. The torsional vibration damper of claim 11 wherein the actuating device includes a spring device acting upon the clutch device in an opening direction.

21. The torsional vibration damper of claim 11, wherein the clutch device is a multiplate clutch.

22. The torsional vibration damper of claim 11 further comprising an output shaft.

23. A hybrid drive train comprising:
a combustion engine;
an electrical machine including a stator and a rotor; and,
the torsional vibration damper of claim 11.

24. The hybrid drive train of claim 20, wherein:
the torsional vibration damper includes an output shaft;
the combustion engine is connected to the input part of the torsional vibration damper; and,
the rotor is connected to the output shaft
